(19) United States
(12) Patent Application Publication
(10) Pub. No.: US 2013/0235155 A1
(43) Pub. Date: Sep. 12, 2013

(54) METHOD OF CONVERTING 2D INTO 3D BASED ON IMAGE MOTION INFORMATION

(71) Applicants: Tao Feng, Beijing (CN); Yanding Zhang, Beijing (CN); Dong Yang, Beijing (CN)

(72) Inventors: Tao Feng, Beijing (CN); Yanding Zhang, Beijing (CN); Dong Yang, Beijing (CN)

(73) Assignee: BEIJING GOLAND TECH CO., LTD., Beijing (CN)

(21) Appl. No.: 13/818,101

(22) PCT Filed: Aug. 18, 2011
(86) PCT No.: PCT/CN11/01377

§ 371 Date: Feb. 21, 2013

(51) Int. Cl. H04N 13/00

(52) U.S. Cl. CPC H04N 13/0022
USPC 348/43

(57) ABSTRACT

The present invention relates to the field of 2D to 3D conversion, in particular discloses a method of converting 2D into 3D based on image motion information. The method comprises: S1, obtaining a depth value of each pixel of the input 2D image based on a method of motion estimation; S2, accumulating the depth value of each pixel in accordance with a luminance value of each pixel to obtain a depth image of the input 2D image; S3, reconstructing a left eye and/or a right eye image based on a reconstruction of depth image in accordance with the depth image obtained in the step of S2; S4, combining the left eye image and the right eye image obtained in the step of S4 and outputting a combined image to obtain the 3D image. In the method herein, due to the accumulation process of the depth value obtained by the motion estimation, the resulted depth image is continuous and dense, which improves the quality of the reconstructed image and the 3D visual effect.

### TECHNICAL FIELD

The present application relates to the field of conversion from 2D into 3D, and in particular to a method of converting 2D into 3D based on image motion information.

### BACKGROUND ART

3D (Three Dimensions) TVs have swept the world and become a new trend in the global TV industry. Every major TV manufacturer has launched its own 3D TV. The application of 3D has become more and more popular in people's life. Although 3D films are kept shooting all the time, the 3D resources are still unable to meet the current market needs. A new market desire to convert the resources of 2D (Two Dimensions) into that of 3D automatically has been created. The conversion from 2D into 3D is to generate the second view video based on 2D view content, and the conversion process comprises two aspects of treatment: one is depth estimation for the purpose of obtaining a depth map/image; the other is Depth Image Based Rendering, DIBR. The depth image stores the depth information as grey values in 8 bits (Grey value 0 represents the farthest value, and grey value 255 represents the nearest value). In the past few years, there have been numerous algorithms proposed in the field of 2D to 3D conversion. The algorithm based on motion estimation is commonly used, which obtains the depth image of the input image by the method of motion estimation. However, the wide application of the said method has been limited, because a depth image requires considerable density and precision, but the depth image achieved by the current algorithm converting 2D into 3D based on the motion estimation are sparse, thus different objects cannot be distinguished at the position where they are decomposed, hence the image quality achieved by means of DIBR and thereby the promotion of the related method have been hindered.

### CONTENTS OF THE INVENTION

### Technical Problems to be Solved

The technical problems to be solved by the present invention is to improve the image quality generated by the method of converting 2D into 3D based on image motion information.

### Technical Solution

To solve the aforementioned problem, a method of converting 2D into 3D based on motion estimation is provided, comprising:

S1, obtaining a depth value of each pixel of the input 2D image based on a method of motion estimation;

S2, accumulating the depth value of each pixel in accordance with a luminance value of each pixel to obtain a depth image of the input 2D image;

S3, reconstructing a left eye image and/or a right eye image based on a reconstruction of depth image in accordance with the depth image obtained in the step of S2;

S4, combining the left eye image and the right eye image obtained in the step of S3 and outputting a combined image to obtain a 3D image;

Preferably, the step of S1 further comprises:

S1.1, computing a motion vector of each pixel based on the method of motion estimation;

S1.2, computing the depth value of each pixel respectively according to the motion vector obtained in the step of S1.1.

Preferably, the depth value is calculated by a formula below:

D(x,y)=C*\sqrt{MVₓ²+MV_{y}²};

Preferably, the method of motion estimation is the diamond search algorithm.

Preferably, the step of S2 further comprises:

S2.1, accumulating the depth value of each pixel beginning from the first row of the input 2D image to obtain an accumulated depth value D(x, y) of each pixel;

S2.2, obtaining a normalized depth value D(x,y)″ by normalizing the accumulated depth value to an interval [0, 255] according to the formula below:

$${D ( x , y )}^{″} = min ( 255 , max ( 0 , \frac{{D ( x , y )}^{′}}{{sum}^{′}} * DEPTH\_SCALE ) ) ;$$

wherein, I (x,y) is the luminance value of the pixel at the position (x,y) with a value interval [0, 255]; SCALE is the scaling factor of the luminance value; width is the width value of the input 2D image, height is the height value of the input 2D image; DEPTH_SCALE is the scaling factor of the depth value;

$${sum}^{′} = \frac{sum}{sidth * height} ;$$

$$sum = {\sum }_{x = 0 , y = 0}^{n} {D ( x , y )}^{′} ;$$

Preferably, the step of S2.1 further comprises:

S2.11, if y is zero, then D(x,y)′=0, otherwise, carrying out the step of S2.12;

S2.12, if y is an odd number and x is zero, then D(x,y)′=D(x,y−1)′+D(x,y);

if x is not zero, then

D(x,y)′=min(D(x−1,y)′+|I(x+1,y)−I(x−1,y)|*SCALE,D(x,y−1)′)+D(x,y)*(1+|I(x,y−1)−I(x,y+1)|*SCALE);

otherwise, carrying out the step of S2.13;

S2.13, if x=width−1, then D(x,y)′=D(x,y−1)′+D(x,y); otherwise,

D(x,y)′=min(D(x−1,y)′+|I(x+1,y)−I(x−1,y)|*SCALE,D(x,y−1)′)+D(x,y)*(1+|I(x,y−1)−I(x,y+1)|*SCALE);

S2.14, if y<height, then returning to the step of S2.11,

Otherwise, outputting the result D(x,y)′ of the step of S2.12 or S2.13.

Preferably, SCALE=0.1.

Preferably, DEPTH_SCALE=120.

Preferably, the step of S3 further comprises:

S3.1, reconstructing the left eye or right eye image according to the formula below:

$$x 1 = xc + \frac{tx}{2} \frac{f}{z}$$

$$xr = xc - \frac{tx}{2} \frac{f}{z}$$

$$1 / Z = {{D}_{z} ( x , y )}^{″} - Dzero ;$$

wherein, xl and xr are the positions in left eye image and right eye image corresponding to the position xc of the input 2D image respectively; f is the focal length of the eye; tx is the distance between the two eyes; Z is the distance between the pixel point and human eye; Dzero is the position of zero plane with a value interval [0,255];

S3.2, copying the pixel value at the position (xc,y) to the corresponding position (xl,y) or (xr,y);

Preferably, Dzero=255.

### Beneficial Effect

Due to the accumulation process of the depth value obtained by the motion estimation, the depth image provided in the method described herein is continuous and dense, which improves the quality of the reconstructed image and the 3D visual effect.

### BRIEF DESCRIPTION OF THE DRAWINGS

FIG. 1 is a flow chart of the method of converting 2D into 3D based on image motion information according to one embodiment of the present application;

FIG. 2 is a schematic view of the visual model of a dual-camera.

### SPECIFIC MODE FOR CARRYING OUT THE INVENTION

Hereinafter the method of converting 2D into 3D based on image motion information provided by the present invention will be described in detail with reference to the accompanying drawings and embodiments.

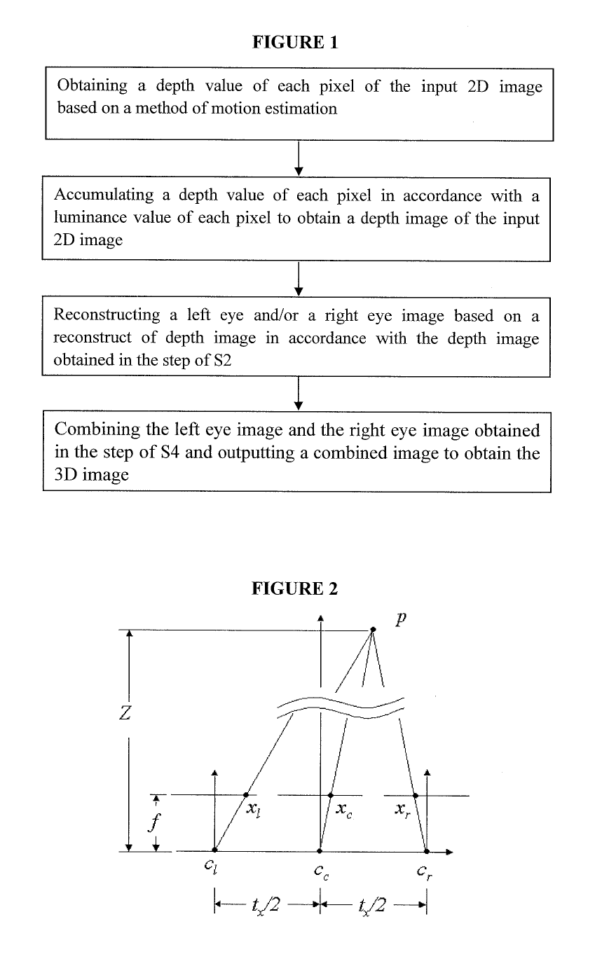

As shown in FIG. 1/2, the method of converting 2D into 3D based on image motion information according to one embodiment of the present application comprises:

S1, obtaining a depth value of each pixel of the input 2D image based on a method of motion estimation;

S2, accumulating the depth value of each pixel in accordance with a luminance value of each pixel to obtain a depth image of the input 2D image;

S3, reconstructing a left eye and/or a right eye image based on a reconstruction of depth image in accordance with the depth image obtained in the step of S2;

S4, combining the left eye image and the right eye image obtained in the step of S3 and outputting a combined image to obtain the 3D image.

In the method of this embodiment, the step of S1 further comprises:

S1.1, computing a motion vector of each pixel based on the method of motion estimation, wherein, the method of motion estimation adopts the diamond search algorithm. It begins with big diamond search which is followed by small diamond search, and ends with the resulted motion vector with integral pixel precision. Certainly, other search algorithms are also applicable, without limiting the method described herein.

S1.2, computing the depth value of each pixel respectively according to the motion vector obtained in the step of S1.1.

wherein, the depth value is calculated from a formula below:

D(x,y)=C*\sqrt{MVₓ²+MV_{y}²} (1)

y is the row where the pixel locates; x is the column where the pixel locates; D (x,y) is the depth value of the pixel at an unknown position (x,y); MVx and MVy are motion vectors in the horizontal direction and vertical direction of the pixel, respectively; C is a constant, in this embodiment C=1.

To enhance the search precision of step S1.1 and to lessen the influence on the precision of motion search caused by noise (in particular those salt-and-pepper noise added in some video resource), before carrying out the motion search of step S1.1, a de-noising processing can be conducted on the input 2D image. This processing is commonly known by those skilled in this art and herein no further details will be given thereto.

Since the motion vector obtained by the motion search is discontinuous, the depth image obtained by direct computation is quite sparse, while the actual depth image should be dense. Therefore, the present application conducts an accumulation of the depth values obtained by computing the motion vector according to the luminous information of each pixel.

In this embodiment, the step of S2 further comprises:

S2.1, accumulating the depth value of each pixel beginning from the first row of the input 2D image to obtain an accumulated depth value D(x,y)′ of each pixel, further comprising:

S2.11, if y is zero, then D(x,y)′=0, otherwise, carrying out the step of S2.12;

S2.12, if y is an odd number and x is zero, then D(x,y)′=D(x,y−1)′=D(x,y), if x is not zero, then

D(x,y)′=min(D(x−1,y)′+|I(x+1,y)−I(x−1,y)|*SCALE,D(x,y−1)′)+D(x,y)*(1+|I(x,y−1)−I(x,y+1)|*SCALE);

otherwise, carrying out the step of S2.13;

S2.13, if x-width-1, then D(x,y)′=D(x,y−1)′+D(x,y), otherwise,

D(x,y)′=min(D(x−1,y)′+|I(x+1,y)−I(x−1,y)|*SCALE,D(x,y−1)′)+D(x,y)*(1+|I(x,y−1)−I(x,y+1)|*SCALE)

S2.14, if y<height, then returning to the step of S2.11, otherwise outputting the result D(x,y)′ of the step of S2.12 or S2.13;

S2.2, obtaining a normalized depth value D(x,y)″ and hence obtaining a continuous and dense depth image by normalizing the accumulated depth value to an interval [0, 255] according to the formula below:

$${D ( x , y )}^{″} = min ( 255 , max ( 0 , \frac{{D ( x , y )}^{′}}{{sum}^{′}} * DEPTH\_SCALE ) ) ; \qquad ( 6 )$$

wherein, I (x,y) is the luminance value of the pixel at the position (x,y) with a value interval [0, 255]; SCALE is the scaling factor of the luminance value, in this embodiment SCALE=0.1; width is the width value of the input 2D image; height is the height value of the input 2D image; DEPTH_SCALE is the scaling factor of the depth value, in this embodiment, DEPTH_SCALE=120;

$$\begin{matrix}{sum}^{′} = \frac{sum}{sidth * height} & ( 7 ) \\ sum = {\sum }_{x = 0 , y = 0}^{n} {D ( x , y )}^{′} ; & ( 8 )\end{matrix}$$

S2.3, conducting an asymmetric Gaussian filtering on the normalized depth value D(x,y)″ obtained in the step of S2.2 to obtain an ultimate depth value D_{z}(x,y)′. The asymmetric Gaussian filtering is commonly known by those skilled in this art and herein no further details will be given thereto.

As a projection transformation will be conducted in the horizontal direction of the image, the depth values should keep continuous as far as possible in the horizontal direction to avoid the influence of excessive noise caused by the motion search. Therefore, the present application does not apply the horizontal gradient value to the scale motion for achieving the depth value.

Due to the human visual property, the visual perception of 70% people relies heavily on the right eye, and 20% on the left eye. To reduce the computation amount, when using DIBR to reconstruct image, the present invention only reconstructs the eye on which is not heavily relied, herein defaulting to the left eye. Moreover, although the quality of a reconstructed frame in this case is poor, it does not affect the 3D visual effect. Consequently, the step of S3 in this embodiment takes the left eye image as an example, namely, in the step of S3, the left eye image is reconstructed based on DIBR according to the depth image obtained in the step of S2.

As shown in FIG. 2/2, wherein Cc is the input 2D image; Cl is the reconstructed left eye image; Cr is the reconstructed right eye image; f is the focus length of the eye; tx is the baseline distance, i.e., the distance between the two eyes; Z is the distance between the observed pixel point and the human eye, which is computed in accordance with the formula (11); Dzero is the position of zero plane with a value interval [0,255], in this embodiment a value of 255 is taken. Formula (9), (10) are projection geometrical relationship in FIG. 2 corresponding to the same pixel in Cl, Cr and Cc. According to the formula (9), (10), the value of xl or xr corresponding to the position xc of the input 2D image is computed, and then the pixel value at the position (xc, y) is copied to the corresponding position (xl, y) or (xr, y). (copied to (xl, y) in this embodiment).

Namely the step of S3 further comprises:

S3.1, reconstructing the left eye or right eye image according to the formula below:

$$\begin{matrix}x 1 = xc + \frac{tx}{2} \frac{f}{z} & ( 9 ) \\ xr = xc - \frac{tx}{2} \frac{f}{z} & ( 10 ) \\ 1 / Z = {{D}_{z} ( x , y )}^{″} - Dzero ; & ( 11 )\end{matrix}$$

wherein, xl and xr are the positions in left eye image and right eye image corresponding to the position xc of the input 2D image respectively; f is the focal length of the eye; tx is the distance between the two eyes; Z is the distance between the pixel point and the human eye; Dzero is the position of zero plane with a value interval [0,255];

S3.2, copying the pixel value at the position (xc,y) to the corresponding position (xl,y) or (xr,y).

To lessen the zigzagging effect of the reconstructed image, the input 2D image is scaled in the horizontal direction firstly, in order to enhance the pixel precision at the time of projection. In this embodiment, the image is stretched in the horizontal direction to be four times of its original size. In line with the aforementioned visual relation of human eye, the value x of ¼ pixel precision to which every xl in each row corresponds is computed. If the value x to which xl corresponds exceeds the boundary of the image, then the pixel value at the position xl is obtained based on interpolation; if there are multiple xl corresponding to the same x, then take the xl which makes D(x,y)″ largest, then the pixel values of other xl are obtained based on interpolation; if there is an exclusive x to which xl corresponds, then the pixel value at the position xl is the pixel value at the position x in the input 2D image.

The aforementioned embodiments of the present invention are disclosed for illustrative purpose only but not limiting the scope thereof. Those skilled in the art will appreciate that various changes and variants can be made thereto without departing from the scope and spirit of the invention. Therefore all equivalent technical solutions also fall within the scope of the present invention.which should be defined by the appended claims.

### INDUSTRIAL APPLICABILITY

The reconstructed images obtained by the method of converting 2D into 3D based on image motion information described herein have high image quality, excellent 3D visual effect, and hence the present method is of great importance for the market development in impelling the automatic conversion from 2D resource into 3D.

What is claimed is:

1. A method of converting 2D into 3D based on image motion information, characterized in that, the method comprises the following steps:
S1, obtaining a depth value of each pixel of the input 2D image based on a method of motion estimation;
S2, accumulating the depth value of each pixel in accordance with a luminance value of each pixel to obtain a depth image of the input 2D image;
S3, reconstructing a left eye image and/or a right eye image based on a image reconstruction of depth image in accordance with the depth image obtained in the step of S2;
S4, combining the left eye image and the right eye image obtained in the step of S4, and outputting a combined image to obtain the 3D image.

2. The method of converting 2D into 3D based on image motion information of claim 1, characterized in that, the step of S1 further comprises:
S1.1, computing a motion vector of each pixel based on the method of motion estimation;
S1.2, computing the depth value of each pixel respectively according to the motion vector obtained in the step of S1.1.

3. The method of converting 2D into 3D based on image motion information of claim 2, characterized in that, the method of motion estimation is the diamond search algorithm.

4. The method of converting 2D into 3D based on image motion information of claim 3, characterized in that, the step of S2 further comprises:
S2.1, accumulating the depth value of each pixel beginning from the first row of the input 2D image to obtain an accumulated depth value D(x,y)′ of each pixel;
S2.2, obtaining a normalized depth value D(x,y)″ by normalizing the accumulated depth value to an interval [0, 255] according to the formula below:
$${D ( x , y )}^{″} = min ( 255 , max ( 0 , \frac{{D ( x , y )}^{′}}{{sum}^{′}} * DEPTH\_SCALE ) ) ;$$
wherein, I (x, y) is the luminance value of the pixel at the position (x, y) with a value interval [0, 255]; SCALE is the scaling factor of the luminance value;
width is the width value of the input 2D image; height is the height value of the input 2D image; DEPTH_SCALE is the scaling factor of the depth value;
$${sum}^{′} = \frac{sum}{sidth * height} ;$$
$$sum = {\sum }_{x = 0 , y = 0}^{n} {D ( x , y )}^{′} .$$

5. The method of converting 2D into 3D based on image motion information of claim 4, characterized in that, the step of S2.1 further comprises:
S2.11, if y is zero, then D(x,y)′=0, otherwise, carrying out the step of S2.12;
S2.12, if y is an odd number and x is zero, then D(x,y)′=D(x,y−1)′+D(x,y);
if x is not zero, then
D(x,y)′=min(D(x−1,y)′+|I(x+1,y)−I(x−1,y)|*SCALE,D(x,y−1)′)+D(x,y)*(1+|I(x,y−1)−I(x,y+1)|*SCALE);
otherwise, carrying out the step of S2.13;
S2.13, if x=width−1, then D(x,y)′=D(x,y−1)′+D(x,y); otherwise,
D(x,y)′=min(D(x−1,y)′+|I(x+1,y)−I(x−1,y)|*SCALE,D(x,y−1)′)+D(x,y)*(1+|I(x,y−1)−I(x,y+1)|*SCALE);
S2.14, if y<height, then returning to the step of S2.11, otherwise outputting the result D(x,y)′ of the step of S2.12 or S2.13.

6. The method of converting 2D into 3D based on image motion information of claim 5, characterized in that, SCALE=0.1.

7. The method of converting 2D into 3D based on image motion information of claim 5, characterized in that, DEPTH_SCALE=120.

8. The method of converting 2D into 3D based on image motion information of claim 5, characterized in that, the step of S3 further comprises:
S3.1, reconstructing the left eye or right eye image according to the formula below:
$$x 1 = xc + \frac{tx}{2} \frac{f}{z}$$
$$xr = xc - \frac{tx}{2} \frac{f}{z}$$
$$1 / Z = {{D}_{z} ( x , y )}^{″} - Dzero ;$$
wherein, xl and xr are the positions in left eye image and right eye image corresponding to the position xc of the input 2D image respectively; f is the focal length of the eye; tx is the distance between the two eyes; Z is the distance between the pixel point and human eye; Dzero is the position of zero plane with a value interval [0,255];
S3.2, copying the pixel value at the position (xc, y) to the corresponding position (xl, y) or (xr, y).

9. The method of converting 2D into 3D based on image motion information of claim 8, characterized in that, Dzero=255.
